(19) United States
(12) Patent Application Publication
(10) Pub. No.: US 2014/0052672 A1
(43) Pub. Date: Feb. 20, 2014

(54) Telenostics point of performance driver performance index

(71) Applicants: Ronald E. Wagner, Fleming Island, FL (US); Robert Charlton, Fredericksburg, VA (US); David Sada, Orange Park, FL (US)

(72) Inventors: Ronald E. Wagner, Fleming Island, FL (US); Robert Charlton, Fredericksburg, VA (US); David Sada, Orange Park, FL (US)

(73) Assignee: BAE Systems and Information and Electronic Systems Integration, Inc.

(21) Appl. No.: 12/807,919

(22) Filed: Sep. 16, 2010

Related U.S. Application Data
(60) Provisional application No. 61/342,090, filed on Apr. 9, 2010.

(51) Int. Cl. G06Q 90/00

(52) U.S. Cl. 705/500

(57) ABSTRACT

Fleet management is apprised of the effects of driver's performance through the use of a driver performance index that is a relative calculation of how well a driver is operating equipment in which the driver performance index is tailorable to each organization so that the relative value of each element of the calculation can be weighted, with the driver performance index including metrics that indicate the way the vehicle is being operated whether before, during or after the operating period.

### RELATED APPLICATIONS

This application claims rights under 35 USC §119(e) from U.S. Application Ser. No. 61/342,090 filed Apr. 9, 2010, the contents of which are incorporated herein by reference.

### FIELD OF THE INVENTION

This invention relates to fleet maintenance systems more particularly to a system for ascertaining driver performance through the utilization of a driver performance index.

### BACKGROUND OF THE INVENTION

Vehicle operators in general drive their vehicles without regard to the cause and effect of the impact their driving has on maintenance, emissions and other drivers on the road including, for instance mishaps and/or accidents.

Fleet managers in general are unaware of day to day driving habits and have no way to associate vehicle condition and remaining useful life of a vehicle related to a particular driver and the driver's habits. Too often a single approach is not comprehensive enough such as for instance the use of signs that alert the public to “call this number to report my driving” on the back of a commercial vehicle.

The data to bring together a holistic view of a driver and the impact a driver has on the entire organization is lost between actual events and the opportunity to capitalize on such information, both internally of and externally to the organization responsible for the driver. Organizations are unable to associate good driving practices to a reduction, for instance, in insurance rates or to reduce legal fees during accident mitigation. Moreover, maintenance activities are unable to identify, plan and optimize those maintenance activities that are directly linked to the frequency of use or driving practice that causes failures at a faster rate.

### SUMMARY OF INVENTION

In order to apprise management of the effects of driver's performance, in the subject invention a driver performance index is developed that is a relative calculation of how well a driver is operating equipment. This calculation is tailorable to each organization so that the relative value of each element of the calculation can be aligned to the goals and objectives that are defined as success by each organization. The driver performance index ensures that the way a vehicle is being operated, whether before, during or after the operating period is taken into account, as well as customer feedback including from driver complaint hotlines. Moreover, attendance, task performance and records from the various Department of Motor Vehicles are all incorporated in a comprehensive view to ascertain how a driver is operating the equipment and what the relative value of these operations are to an organization.

In one embodiment, the performance index is calculated using an algebraic equation relating to a number of inputs that produces for instance a score between 0 and 100 indicating the operator's performance compared to, for instance, the rest of the fleet. While the inputs may be equally weighted initially, the weights can be tailored to an organization's goals.

In summary, fleet management is apprised of the effects of driver's performance through the use of a driver performance index that is a relative calculation of how well a driver is operating equipment in which the driver performance index is tailorable to each organization so that the relative value of each element of the calculation can be weighted, with the driver performance index including metrics that indicate the way the vehicle is being operated whether before, during or after the operating period.

### BRIEF DESCRIPTION OF THE DRAWINGS

These and other features of the subject invention will be better understood in connection with the Detailed Description, in connection with the Drawings, of which:

FIG. 1 is a diagrammatic illustration of the calculation of the performance index from a number of factors including vehicle information, complaints and task performance;

FIG. 2 is a chart showing performance index inputs in one embodiment of the subject invention;

FIG. 3 is a diagrammatic illustration showing the types of vehicle information that may be useful in calculating the performance index;

FIG. 4 is a chart indicating task performance in terms of operator versus ideal job duration, job completion accuracy and on-time arrivals;

FIG. 5 is a chart illustrating the utilization of an attendance record as an input to the performance index of FIG. 1;

FIG. 6 is a listing of the Department of Motor Vehicles information that is useful as an input to the performance index of FIG. 1;

FIG. 7 is a listing of the types of complaints that may be applicable to the performance index of FIG. 1;

FIG. 8 is a listing of the types of weather related information that is useful in the performance index of FIG. 1;

FIG. 9 is a diagrammatic illustration of the type of information provided for the performance index of FIG. 1 in which task performance is defined in three categories: operator versus ideal performance, job completion accuracy, and on-time arrival information;

FIG. 10 is a diagrammatic illustration indicating that an algebraic equation relates to a number of inputs and produces a score indicating the operator's performance compared to the rest of the fleet, with inputs weighted by significance, and with the performance index easily tailored according to a customer's needs;

FIG. 11 is a listing of other possible inputs including successful repair attempts, route negotiation and the disregarding of speed limits;

FIG. 12 is a listing of further possible inputs including sensing of for instance lateral acceleration, hard braking and seatbelt use;

FIG. 13 is a listing of the coefficients and operator logic equations for use in the calculation of the performance index of FIG. 1;

FIG. 14 is a graph of driver score versus number of occurrences of driver evaluation parameters;

FIG. 15 is a chart of weather correction factors for use in weighting weather in the driver performance index of FIG. 1;

FIG. 16 is a chart describing the operator logic algorithm for assigning operator adjusted performance weights for use in the driver performance index; and,

FIG. 17 is a chart describing the final operator performance in which the final operator performance is rated at 0.78.

### DETAILED DESCRIPTION

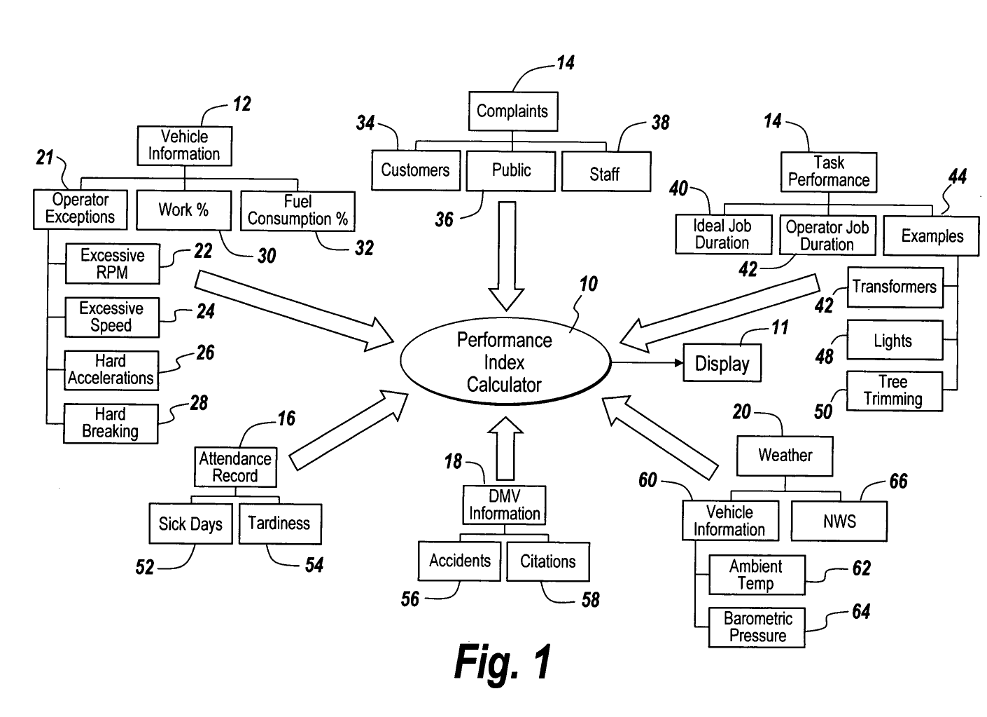

Referring now to FIG. 1, a driver's performance index 10 is shown as being formulated from vehicle information 12, complaints 14 and task performance 16. Other inputs to the performance index can include a driver's attendance record 16 and motor vehicle information 18, along with weather related information 20.

As to vehicle information, operator exceptions 21 to the normal use of the vehicle may include for instance excessive RPM 22, excessive speed 24, hard acceleration 26 or hard braking 28. Moreover, the percentage of time that the vehicle is in operation can be utilized as an input as illustrated at 30, whereas the percentage of fuel consumption per trip, per distance or any other metric may be utilized as a metric to be able to calculate the driver performance index.

As to complaints, these complaints can come from customers 34, the public 36 or from staff 38.

As to task performance, the inputs to the performance index may include ideal job duration 40, operator job duration 42 and examples 44 of the types of jobs involved, for instance maintaining pole-mounted transformers 46, pole-mounted lights 48 or may include tree trimming 50.

Attendance record 16 may include for instance sick days 52 or tardiness 54, whereas Department of Motor Vehicles (DMV) information may include for instance accidents 56 and citations 58.

Finally with respect to the weather, vehicle information 60 may include ambient temperature 62 and barometric pressure 64, with the weather including information from the National Weather Service 66.

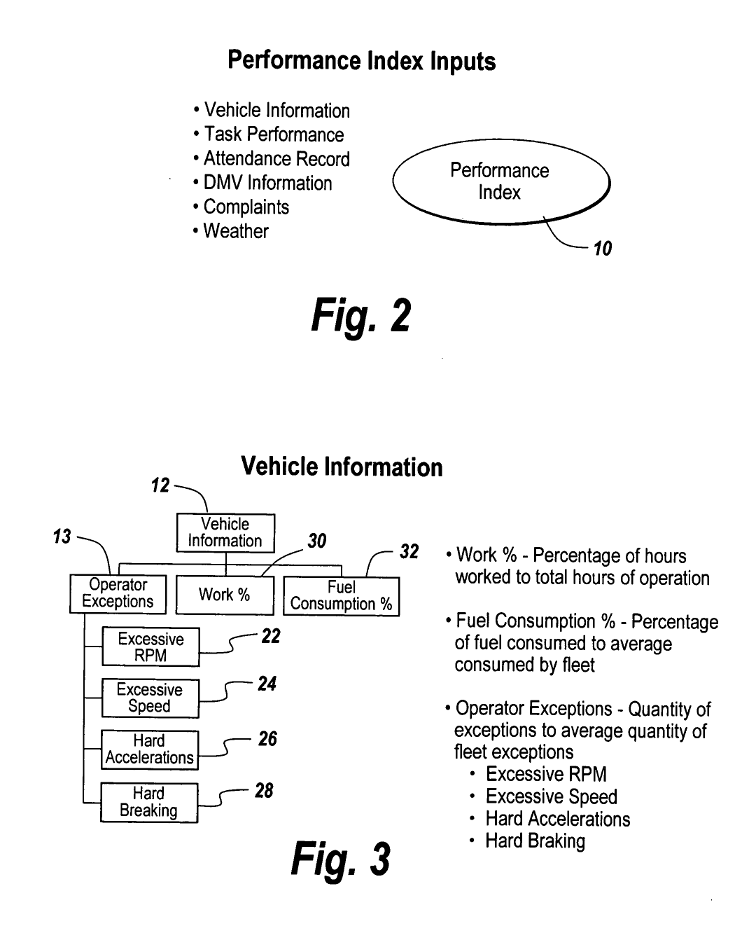

As will be seen from FIG. 2, the performance index 10 may include the aforementioned vehicle information, task performance, attendance record, DMV information, complaints and weather.

Referring to FIG. 3, the vehicle information may include for instance the percentage of hours worked to total of hours of operation, the fuel consumption percentage meaning that the percentage of fuel consumed to the average that is consumed by the fleet, or may include operator exceptions to the quality of driving.

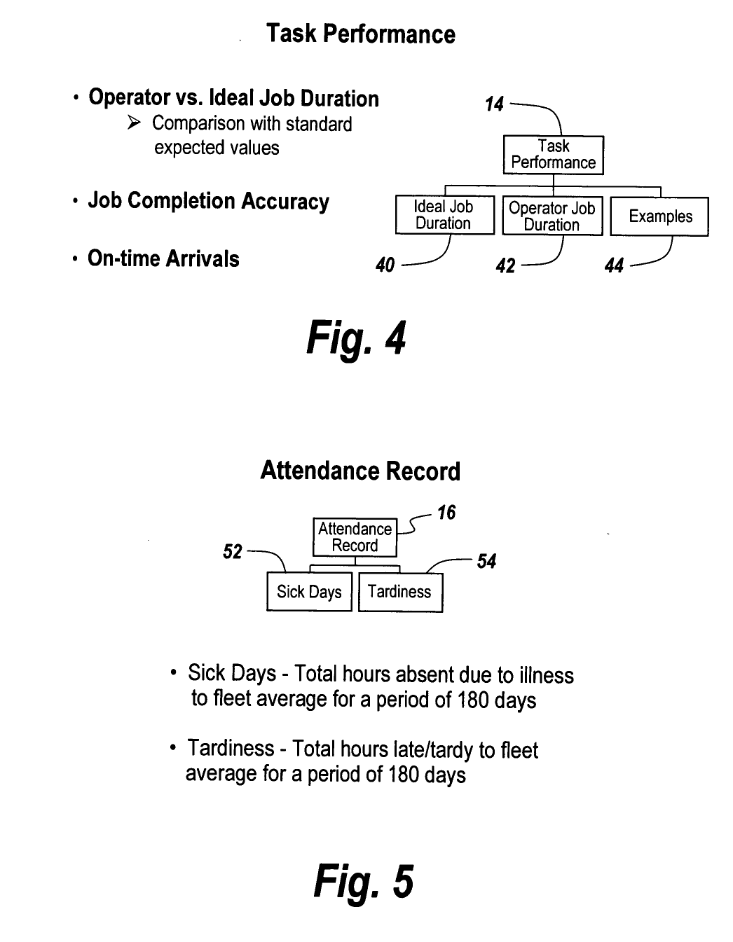

Referring now to FIG. 4, in terms of task performance, it is oftentimes useful in measuring task performance to measure operator versus ideal job duration. This involves a comparison with standard expected values. Also, job completion accuracy is a useful metric as well as on-time arrivals.

Referring now to FIG. 5, in terms of attendance record the sick days utilized which are the total hours absent due to illness as compared to the fleet average for a period of 180 days has been found to be a good metric. Likewise, tardiness in terms of total hours late or tardy versus the fleet average for a period of 180 days is likewise a good metric for the drive performance index.

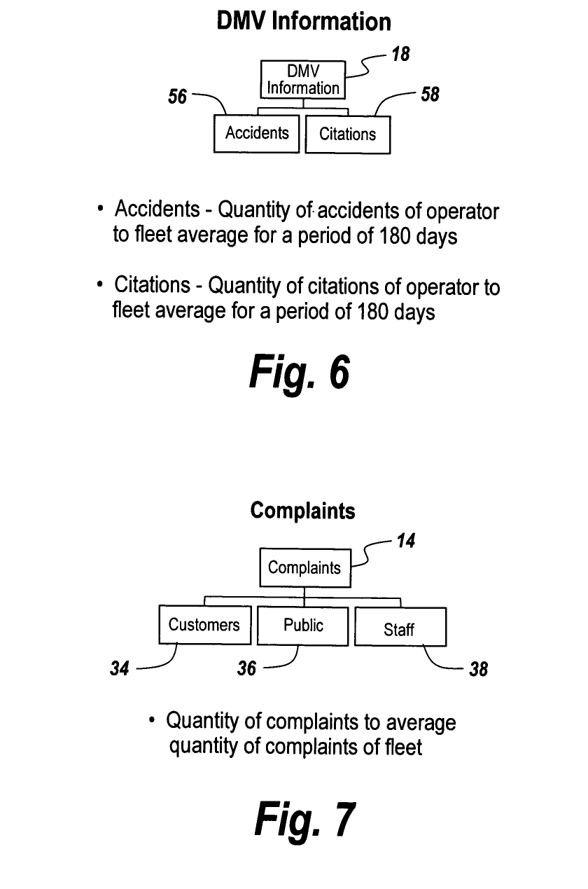

Referring to FIG. 6, as far as the Department of Motor Vehicles information is concerned, the accidents and quality of the accidents relative to the fleet average for a period of 180 days is a good metric, as well as citations in which the quality of the citations with respect to the operator compared to the fleet averages for a period of 180 days.

Referring to FIG. 7, the quantity of complaints versus the average quantity of complaints relative to the rest of the fleet again provides a good performance index metric.

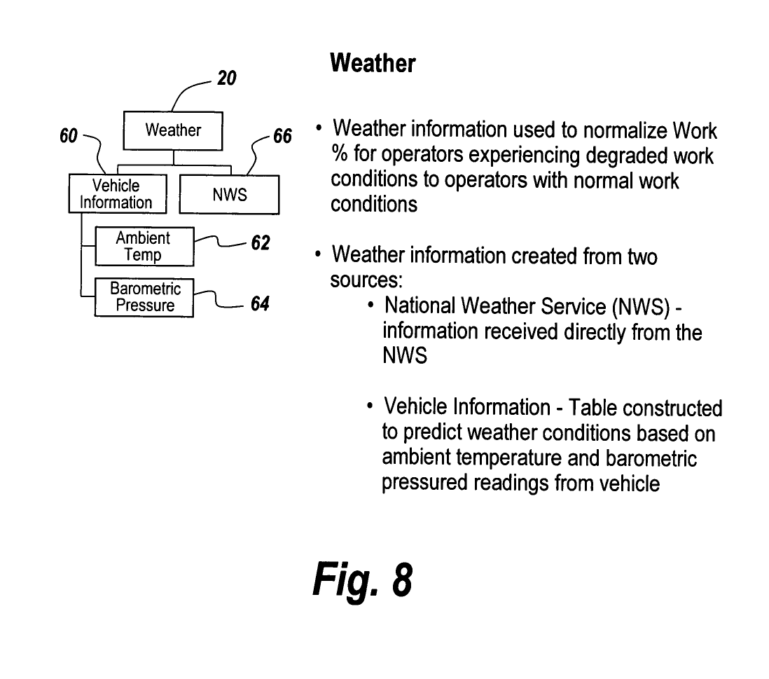

Referring now to FIG. 8, with respect to weather, weather information may be used to normalize the work percentage for operators experience degraded work conditions with respect to operators with normal work conditions. Here, the weather information is created from two sources. One source is the National Weather Service Information received directly from the National Weather Service, with the other information being vehicle information involving a table constructed to predict weather conditions based on ambient temperature and barometric pressure readings from the vehicle.

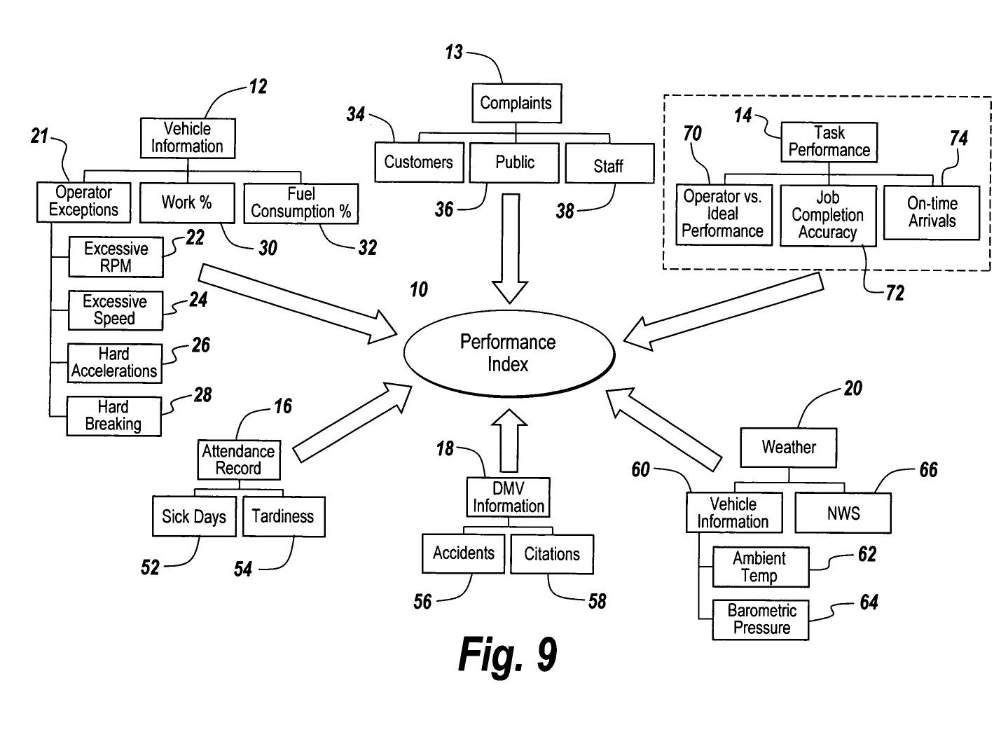

Referring to FIG. 9 in which like items carry like reference characters with respect to FIG. 1, task performance is more generally categorizable in terms of a metric with respect to operator versus ideal performance 70, job completion accuracy 72, or on-time arrivals 74. It will be appreciated that there are indeed a wide variety of task performance metrics that are useful in calculating the driver performance index 10.

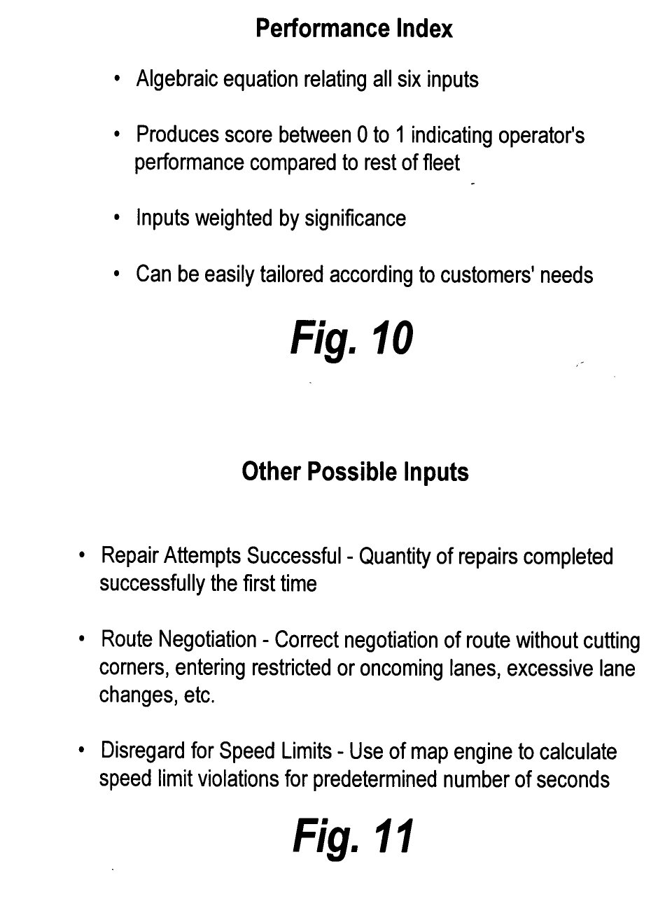

Referring now to FIG. 10, it will be appreciated that one way of calculating the performance index is an algebraic equation relating to a number of inputs, in this case six inputs. In this embodiment the index produces a score between 0 and 1 indicating the operator's performance compared to the remainder of the fleet, whereas the inputs may be weighted by significance. Thus, the performance index equation may be easily tailored to accommodate customer's needs.

Referring to FIG. 11, other inputs can be for instance successful repair attempts including the quantity of repairs completed successfully the first time. Moreover, route negotiation is a useful metric involving the correct negotiation of a route without cutting corners, entering restricted or oncoming lanes or involving excessive lane changes. Another metric is the disregard for speed limits in which a map engine to calculate speed limit violations may be employed.

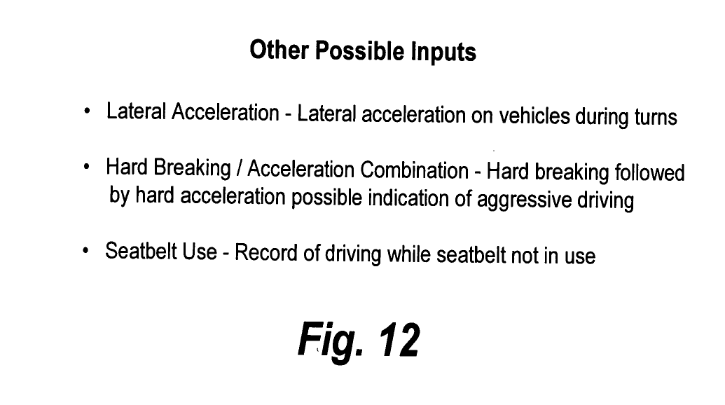

With respect to FIG. 12, other possible inputs can involve sensors on a vehicle. These sensors can include lateral acceleration in terms of measuring the lateral acceleration during terms, hard braking and/or acceleration combinations in which hard braking followed by hard acceleration is a possible indication of aggressive driving. Finally, seatbelt use provides a record of driving.

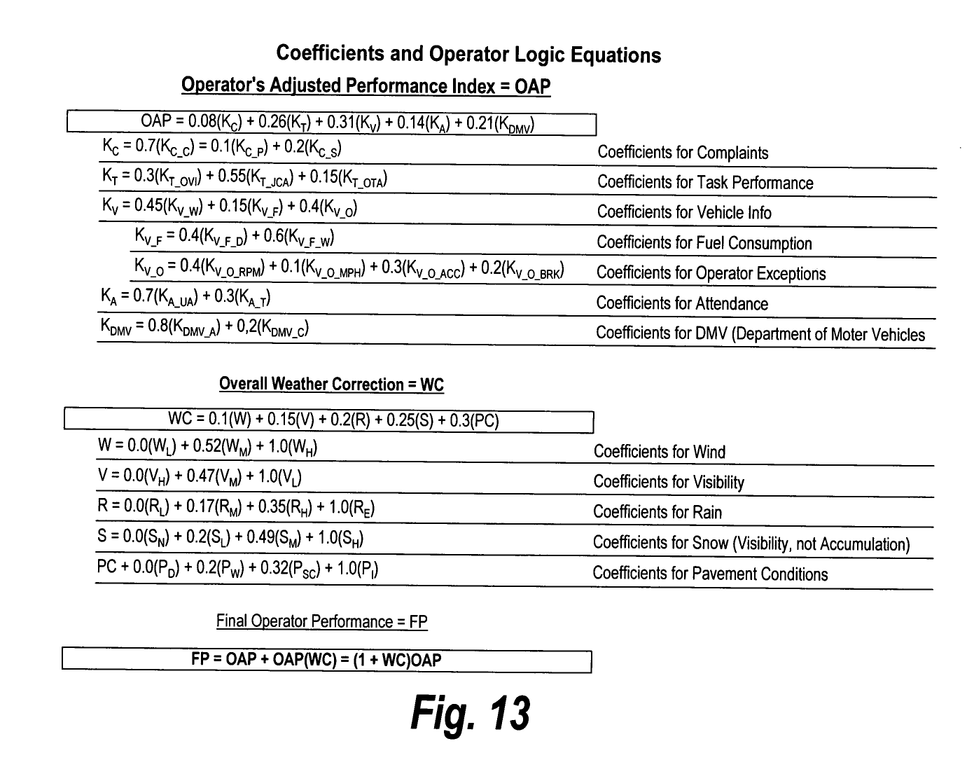

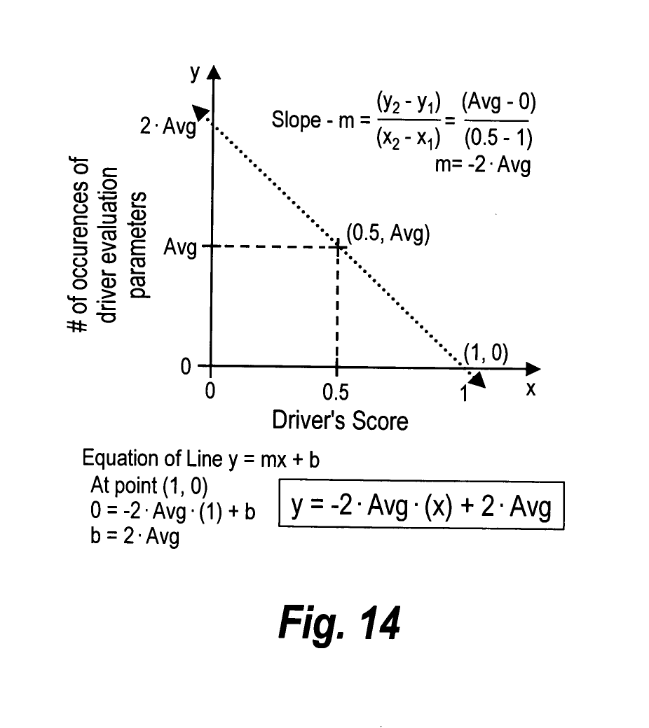

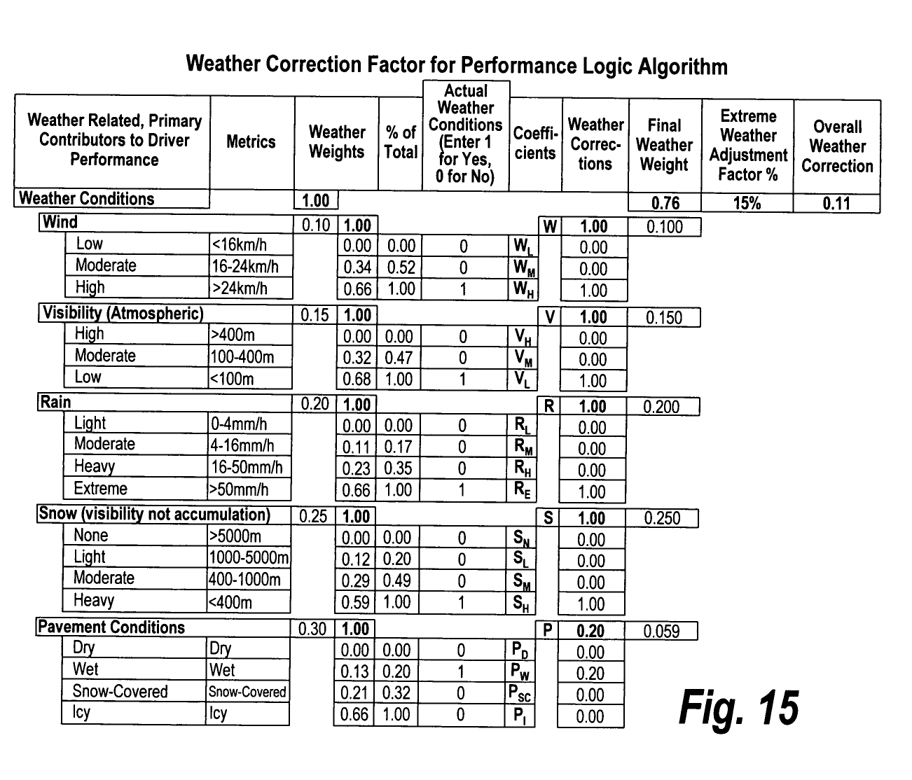

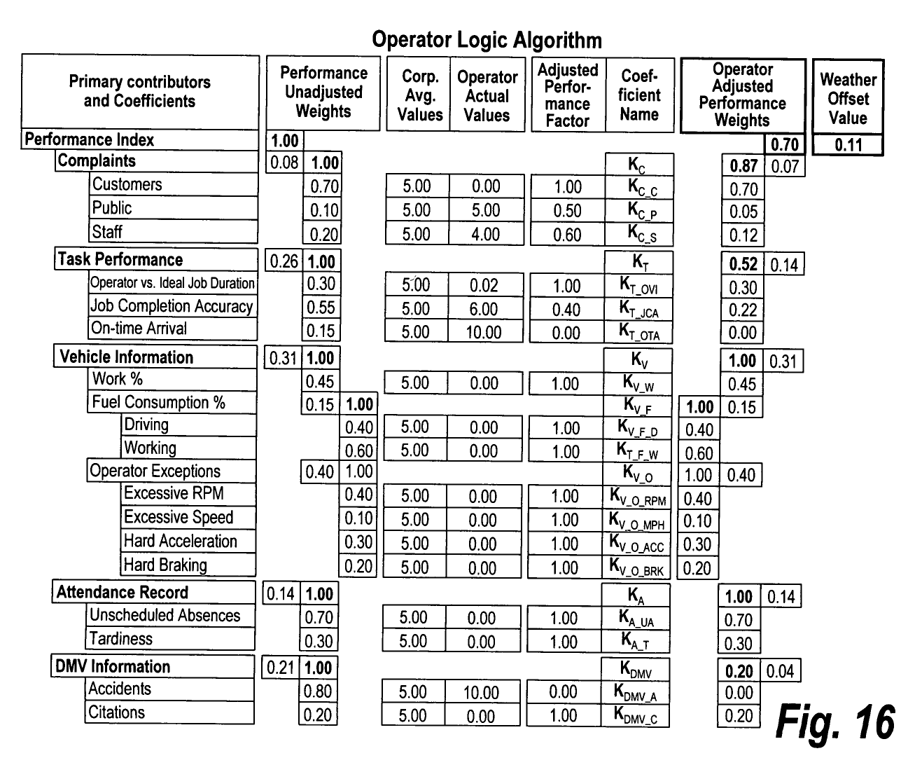

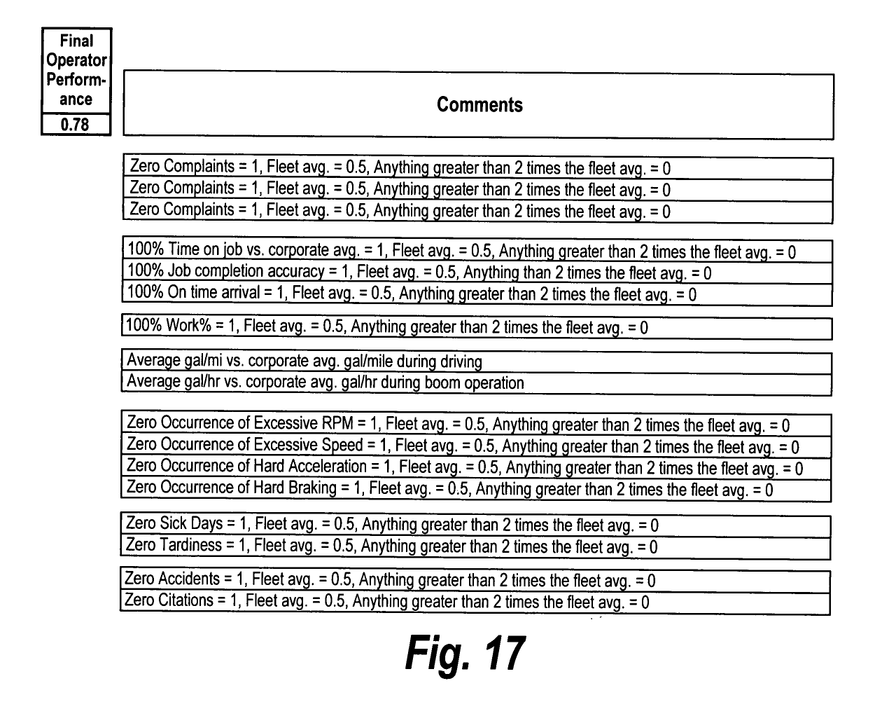

FIGS. 13-17 describe respectively coefficients in operator logic equations, a graph of driver score versus number of occurrences of driver evaluation parameters, weather correction factors, a weighting example for adjusted performance weights and a chart explaining an example of operator performance indicating the explanation for a final operator performance of 0.78.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. (canceled)

2. A method implementable on a computing device having a display for evaluating driver performance, comprising the steps of:
gathering as inputs driver related information and calculating a driver performance index based on the inputs;
wherein the driver performance index is also calculated based on at least:
a comparison between one of the inputs vs. ideal performance comprising values,
a job completion metric comprising completion accuracy, and
a job duration metric comprising a comparison to an ideal job duration and hours worked versus total hours of operation.

3. The method of claim 2, wherein the calculating step includes providing the driver performance index based on an algebraic sum of the inputs.

4. The method of claim 2, wherein the inputs are weighted.

5. The method of claim 2, wherein the driver performance index is based normalized to a fleet average.

6. (canceled)

7. (canceled)

8. (canceled)

9. (canceled)

10. (canceled)

11. (canceled)

12. The method of claim 2, wherein the driver performance index includes an on-arrival time metric.

13. The method of claim 2, wherein the driver performance index includes a driver attendance record metric.

14. The method of claim 13, wherein the attendance record metric includes one of sick days or tardiness.

15. The method of claim 2, wherein the driver performance index includes division of motor vehicle information.

16. The method of claim 15, wherein the division of rooter vehicle information includes one of accidents or citations.

17. The method of claim 2, wherein the driver performance index includes a complaints metric.

18. The method of claim 17, wherein the complaints metric includes severity of a complaint.

19. The method of claim 2, wherein the driver performance index includes a successful repair attempts metric.

20. The method of claim 2, wherein the driver performance index includes a route negotiation metric.

21. The method of claim 20, wherein the route negotiation metric includes traversing a route without cutting corners.

22. The method of claim 20, wherein the route negotiation metric includes excessive lane changes.

23. The method of claim 20, wherein the route negotiation metric includes how many times the driver enters restricted lanes.

24. The method of claim 2, wherein the driver performance index includes an aggressive driving metric.

25. The method of claim 24, wherein the aggressive driving metric includes excessive lateral acceleration

26. The method of claim 24, wherein the aggressive driving metric includes hard braking.

27. The method of claim 2, wherein the driver performance index includes how many times the driver disregards speed limits.

28. The method of claim 2, wherein the driver performance index includes a metric related to seatbelt use.

29. The method of claim 2, wherein the driver performance index includes an excessive RPM metric.

30. The method of claim 2, wherein the driver performance index includes a weather metric.

31. The method of claim 30, wherein the weather metric includes ambient temperature.

32. The method of claim 30, wherein the weather metric includes barometric pressure.

33. The method of claim 30, wherein the weather metric includes taking into account degraded weather conditions.

34. The method of claim 33, wherein the degraded weather conditions are compared with nor, weather conditions.

35. The method of claim 2, wherein the driver performance index includes the percent of time a vehicle is in operation.

36. The method of claim 2, wherein the driver performance index includes a fuel consumption metric.

37. The method of claim 3, the fuel consumption metric is associated with a trip.

38. (canceled)

39. The method of claim 2, wherein the inputs are summed such that an algebraic sum of the inputs includes an algebraic equation relating the inputs being weighted by significance.

40. The method of claim 2, wherein the inputs comprises fuel consumption, work percentage, excessive speed, hard acceleration, hard braking, evaluation of complaints from customers, the public and staff, information from regulatory agencies including agencies including accidents and citations, location dependent weather information including ambient temperature, barometric pressure and weather broadcast service information, and task performance information including ideal job duration and operator job duration.
